(19) United States
(12) Patent Application Publication
(10) Pub. No.: US 2005/0066579 A1
(43) Pub. Date: Mar. 31, 2005

(54) Linear window operator

(76) Inventor: Kurt Winner, Waipahu, HI (US)

Correspondence Address: OSTROLENK FABER GERB & SOFFEN, 1180 AVENUE OF THE AMERICAS, NEW YORK, NY, 100368403, US

(21) Appl. No.: 10/670,818

(22) Filed: Sep. 25, 2003

(51) Int. Cl. E05F 11/28

(52) U.S. Cl. 49/345

(57) ABSTRACT

A linear window operator having a receiver housing with an opening therein and a spring member adjacent the opening. The spring member projects upwardly in a rest position. A hinge bracket is provided which has a flexible member that extends to form a free end configured as a female receiver element. The receiver housing is mounted to the window frame and the hinge bracket is mounted to the window sash. A push rod is slidable through the opening in the receiver housing and has a first, male end connected to the female receiver of the hinge bracket. A second end of the push rod has a detent that is engageable with an engagement lip formed by the edge of the opening in the receiver housing.

### BACKGROUND OF THE INVENTION

The present invention relates to window operators; and, more specifically to a linear operator for opening and closing hinged, i.e., casement and awning, windows.

Window operators generally consist of two types, namely a rotary or crank type operator and a linear or push-pull type operator. Rotary window operators are by far the most popular and frequently used in hinged type windows.

All window operators currently manufactured, both linear and rotary, are sub-assembled mechanisms made primarily from metal components such as zinc, carbon steel, stainless steel, aluminum, and to some extent plastics.

All current operators are subject to corrosion, particularly electrolytic or galvanic corrosion in which two different contacting metals bathed in a salt solution produce a low voltage that rapidly destroys the integrity of the metals. In coastal areas where salt is prevalent in the air, this problem is unacceptable, resulting in hardware failure sometimes in less than twelve months. Even the best stainless steels, when continually wet in a salt solution and deprived of oxygen, will fail in an unusually short period of time.

Since all window operators are sub assemblies of mostly various metal components that mesh and slide against each other, there is a need for a window operator with no inter-meshing parts, no metal components and no metal hinge points.

### SUMMARY OF THE INVENTION

Accordingly, it is an object of the present invention to provide a casement and awning window operator that eliminates the problems of corrosion encountered with conventional operators, particularly in salty coastal environments.

It is another object of the invention to provide an operator that requires no sub-assembled components.

A further object of the invention is to provide a non-metallic flexing connecting member on the operating sash that replaces a conventional hinge or pivot point. The inventive connecting member flexes to accommodate the angularity changes of the operating sash.

It is still a further object of the invention to provide an operator that eliminates the frictional problems associated with inter-meshing components in vary8ing stages of corrosion and neglect as is common with the prior art.

Another object of the invention is to provide a construction that eliminates excessive protrusion of the operator into the interior living area, regardless of the position of the window, i.e., open or closed.

It is still another object of the invention to provide a construction that permits direct on site interchangeability with conventional rotary operators that have failed.

Pursuant to these objects, and others which will become apparent hereafter, one aspect of the present invention resides in a casement and awning window operator having four separate and individual parts, namely, a flexing hinge bracket, a receiver housing, a push rod and a finger pull. The receiver housing is fixed to the mainframe of the window. The push rod passes through the receiver housing. The push rod has notched detents on its upper surface that engage a lip of the receiver housing to hold the sash in position. The push rod has an outer male end in pivotal engagement with the hinge bracket. The hinge bracket is thin in vertical cross section to permit vertical flexibility to accommodate for angularity changes of the sash during operation thereby maintaining engaged alignment with the moving push rod. The pivotal engagement between the hinge bracket and the push rod permits the push rod to be folded flat against the inside of the window frame when in the closed position by manipulating the finger pull attached to the inside end of the push rod.

The invention permits the use of multiple joined push rods to gain additional window opening required in larger size windows. The finger pull which is snapped into the inside female end of the push rod facilitates the manipulation of the push rod in a linear manner to open and close the sash, and vertically to engage and disengage the notch detents and also rotationally at the pivot points to permit folding of the push rod against the inside of the window.

Other features and advantages of the present invention will become apparent from the following description of the invention which refers to the accompanying drawings.

### BRIEF DESCRIPTION OF THE DRAWINGS

FIG. 1 is a perspective view of the overall operator construction with the window frame and sash shown in dashed lines.

FIG. 2 is a section along the line II-II in FIG. 1.

FIG. 3 is a perspective view of the receiver housing.

FIG. 4 is a section along the line IV-IV in FIG. 3.

FIG. 5 is a perspective view of the hinge bracket.

FIG. 6 is a sectional along the line VI-VI in FIG. 5.

FIG. 7 is a view along the line VII-VII in FIG. 6.

FIG. 8 is a section through a push rod.

FIG. 9 is a section showing the engagement of the push rod in the receiver housing.

FIG. 10 shows the disengagement of the push rod in the housing.

FIG. 11 shows the engagement of the push rod in the housing.

### DETAILED DESCRIPTION OF PREFERRED EMBODIMENTS

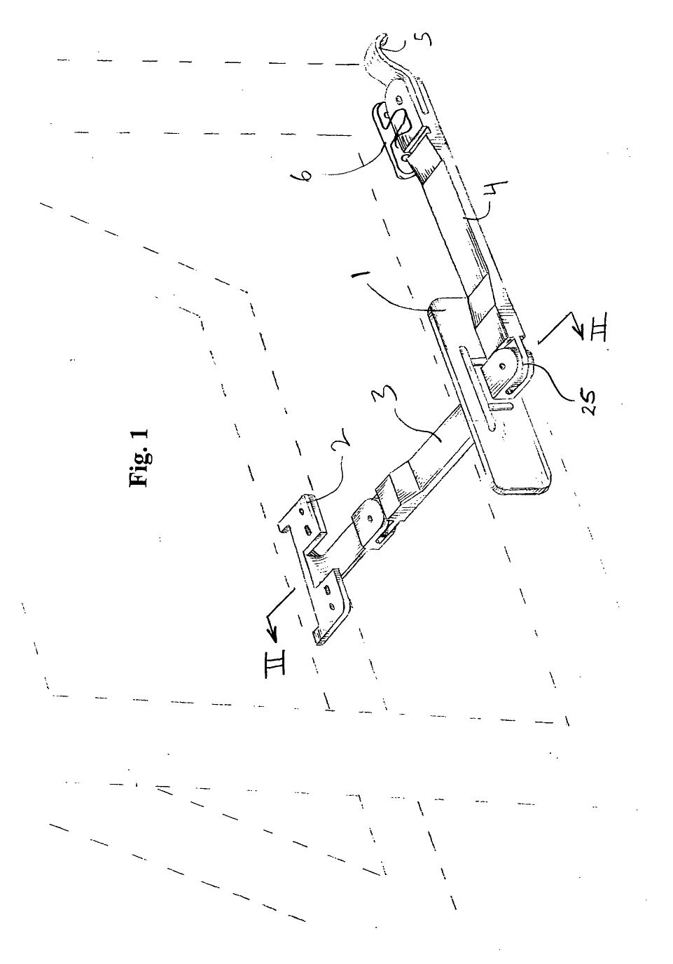

FIG. 1 illustrates the linear window operator connected to a window sash and frame which are indicated in dashed lines. The window operator is composed of a receiver housing 1 that is mounted in the window frame and a hinge bracket 2 that is mounted on the window sash. A push rod 3 passes through an opening in the receiver housing 1 and is connected to the hinge bracket 2. A second push rod 4 can be attached to the push rod 3 to allow further opening of the window. A finger pull 5 is provided at the end of the push rod 4 to facilitate grasping the push rod 4 with a user's hand. A storage bracket 6 can be provided on the window frame for the purposes of holding the push rod in place. The finger pull 5 can alternatively be placed at the end of the push rod 3 if the second push rod 4 is not present.

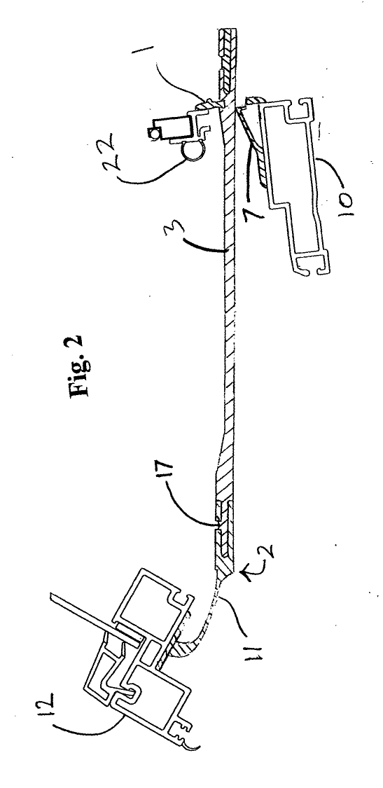

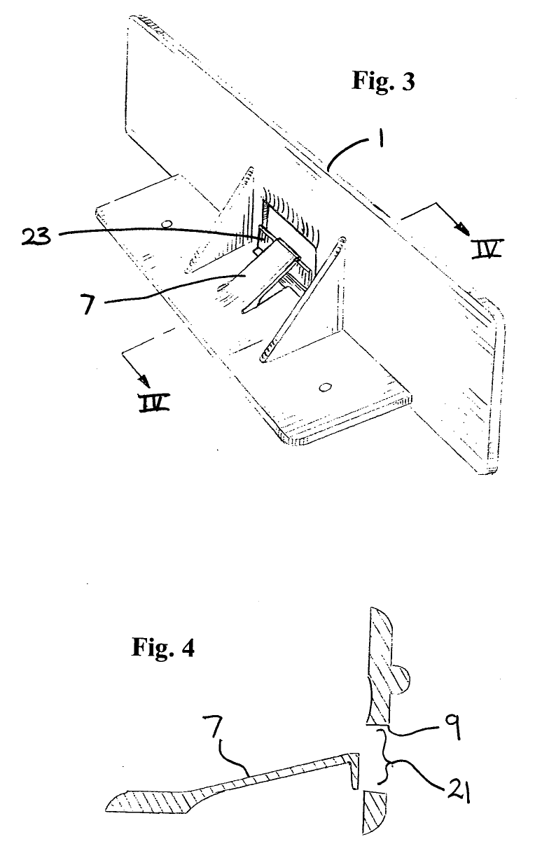

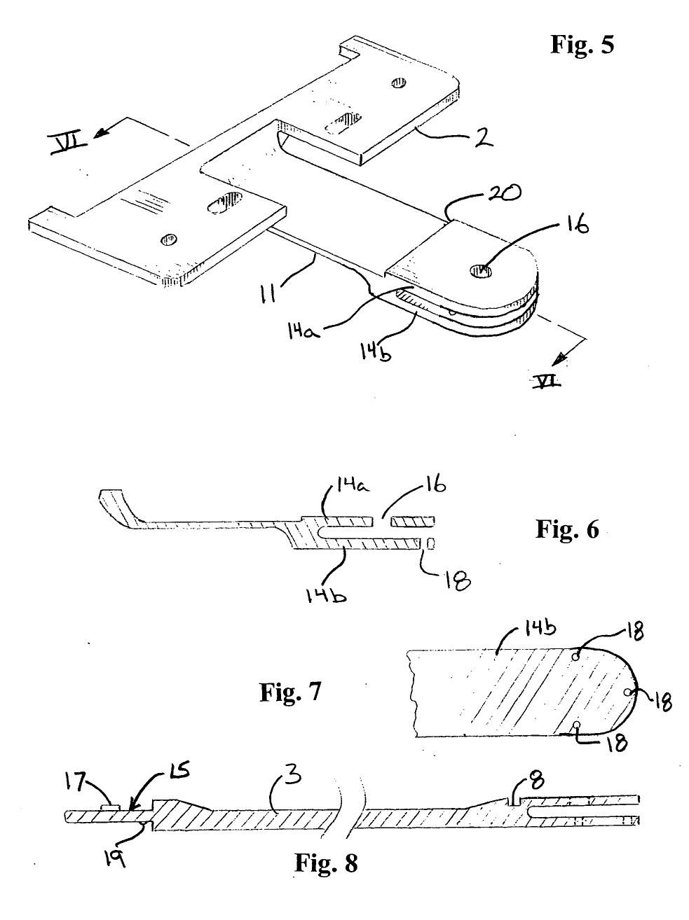

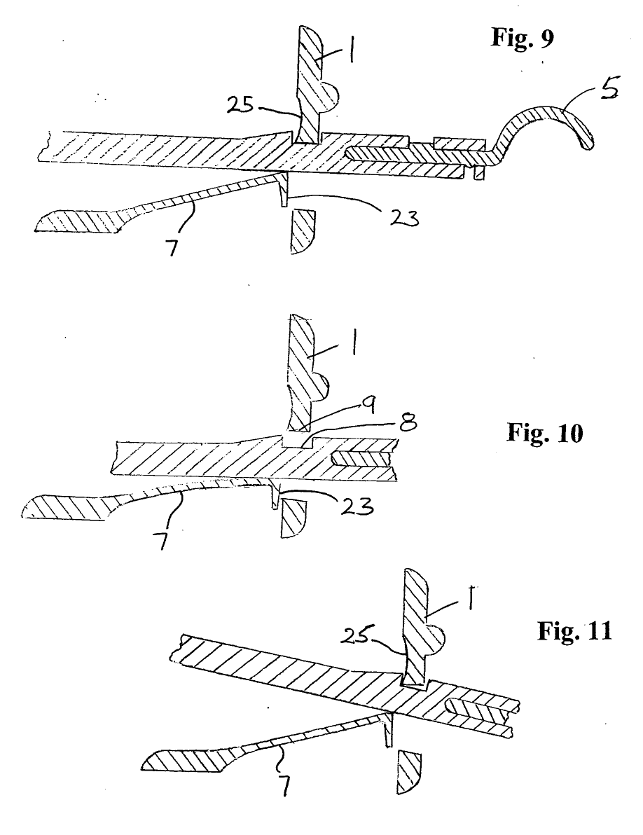

FIG. 2 is a section along the line II-II in FIG. 1. In this drawing it can be seen that the receiver housing 1 has an engagement spring 7 which pushes the push rod 3 upwardly so that an engagement detent 8 in the push rod 3 is engaged by an engagement lip 9 of the receiver housing 1. The engagement detent 8 is held in contact with the engagement lip 9 by the engagement spring 7 to hold the window in a fixed position (see FIGS. 9-11). As seen in FIG. 2, the receiver housing 1 is mounted to the window frame 10. The hinge bracket 2 connects the distal end of the push rod 3 to the window sash 12. The hinge bracket 2 is mounted to the bottom of the window sash and has a flexible portion 11 that extends from the window sash toward the window frame. The end of the flexible portion 11 has two parallel planar portions 14a and 14b that have a space therebetween which forms a female receiver into which a male end 15 of the push rod 3 can be snapped (see FIG. 5). The distance between the elements 14a and 14b is substantially equal to the thickness of the male end 15 of the push rod 3. Furthermore, the member 14a has a pivot hole 16 into which a pivot pin 17 of the male end 15 of the push rod 3 snaps so that the push rod 3 can be pivoted in the female receiver. The other member 14b of the female receiver has a number of pivot detent holes 18 as shown in FIGS. 6 and 7. These detent holes 18 are arranged so that a rotational locating bump 19 on the lower side of the male end 15 of the push rod 3 can engage in the detent holes 18 to hold the push rod 3 in various annular positions relative to the hinge bracket 2. When assembled, the joint between the hinge bracket 2 and the push rod 3 is very rigid and only allows pivoting of the push rod 3 when the window is in the closed position. The push rod 3 is held in either straight alignment with the hinge bracket 2 when the window is open, or is folded in a left or right detent position when the sash is closed. The flexible portion 11 of the hinge bracket 2 has an engagement detent 20 that engages with the engagement lip 9 of the receiver housing 1 due to force from the engagement spring 7 when the sash is in the closed position. In order to open the sash 12 it is necessary to press the push rod 3 downwardly against the engagement spring 7 so as to disengage the engagement detent 20 from the engagement lip 9 and allow the push rod 3 to be pushed through the clearance hole 21 of the receiver housing 1 until the engagement detent 8 of the push rod 3 engages with the engagement lip 9 to hold the window sash 12 in an open position.

Closing the window sash 12 involves pressing the push rod 3 against the engagement spring 7 to release the engagement detent 8 from the engagement lip 9. The push rod 3 is then pulled back through the clearance hole 21 in the receiver housing 1 until the engagement detent 20 once again engages the engagement lip 9. The push rod 3 is then folded either to the left or the right which causes a camming effect as it comes into contact with the raised vertical edges on the face of the receiver housing. By folding the push rod 3 against the window frame, the resulting camming action pulls the attached sash 12 against the window frame 10 and seats the sash 12 tightly against the window gasket 22 in a closed and restrained position with the sash. The pivot detent holes 18 and the locating bump 19 further act to hold the push rod 3 in the closed condition.

The clearance hole 21 in the receiver housing is sized so as to allow the push rod 3 and the hinge bracket 2 to smoothly slide through the clearance hole for the purposes of opening and closing the sash. The engagement spring 7 is preferably molded into the base of the receiver housing 1 as a cantilever spring which creates an upward force on the push rod 3 and the hinge bracket 2 as they pass the spring location. The spring is configured so that it is in the compressed position only during operation (opening and closing) of the window. When engaged in any detent 8, 20, the spring 7 is always in a relaxed upward position. This assures that no plastic deformation or creep of the plastic spring can take place which would result in loss of spring pressure over time.

Located at the free end of the spring 7 is a baffle 23 which effectively closes the open portion of the clearance hole 21 under the push rod 3. The baffle 23 is designed for minimal clearance with the open portion of the clearance hole 21. This clearance allows for movement of the receiver spring 7 while always maintaining an effective baffle to insect, water and air penetration.

If additional sash opening is required, a second push rod 4 is snapped into the first push rod 3. The connection between the push rods 3 and 4 is carried out in a manner similar to the connection between the push rod 3 and the hinge bracket 2. Here the push rod 3 has a female engagement end and the second push rod 4 is configured in the same manner as the first push rod 3 so as to have a male engagement end and a female engagement end. The male engagement end of the second push rod 4 engages the female engagement end of the first push rod 3. Pivot detent holes and a location bump are also provided so that the window can be held in a partially opened condition by rotating the second push rod 4 against the interior of the window frame when the engagement detent 8 of the first push rod 3 is engaged with the engagement lip 9 of the receiver housing 1. When fully opened, the two push rods are stabilized due to the detent holes and the location bump. It should be noted that as the push rod 3 is extended outwardly, the rotating sash movement has an upper component which causes the push rod 3 to tilt upward at the outboard end. This increased upward angle can cause a forced disengagement of the notched detent 8 in the push rod 3 or the notch detent 24 of the push rod 4 from the engagement lip 9 of the receiver housing 1 under high wind loads. This can be avoided by providing a radiused depression 25 in the outside contact surface of the receiver housing 1. By providing the radiused depression a new engagement angle is established which cancels the disengagement forces created by high wind load. This is illustrated in FIGS. 9-11.

A finger pull 5 is snapped into the female end of either of the push rods 3, 4 in the same manner that the push rods 3, 4 snap into either the hinge bracket 2 or the other push rod 3. The male end of each of the push rods 3, 4 has a radiused engagement tongue 25 which permits the push rod to pivot when engaged with the female engagement end of either the other push rod or the hinge bracket 2. The finger pull 5, on the other hand, can be provided with a square engagement tongue so as to prevent rotation of the finger pull 5 when engaged with the female engagement end of the push rod.

Each of the individual components, i.e., the receiver housing 1, the hinge bracket 2, the finger pull 5, and the push rods 3, 4 is a single injection-molded part which allows the inventive design to be manufactured inexpensively and easily assembled.

The invention is not limited by the embodiments described above which are presented as examples only but can be modified in various ways within the scope of protection defined by the appended patent claims.

1. A linear window operator for opening a window having a frame and a movable sash, comprising:
a receiver housing mountable to the window frame, the housing having an opening there-through and a spring member adjacent the opening, the spring member having a rest position;
a hinge bracket mountable to the window sash, the hinge bracket having a flexible member extending therefrom so as to form a free end, the free end being formed with a receiver element; and
a push rod having a first end and a second end, the first end of the push rod being configured as an engagement member releasably engaged with the receiver element of the flexible member of the hinge bracket, the push rod being arranged in the through opening of the receiver housing so as to be slidable there through, the push rod having a detent adjacent its second end that is engageable with an engagement lip formed by an upper edge of the opening in the receiver housing, the spring member being arranged to hold the detent in engagement with the lip in the rest position so that the detent can be disengaged from the lip by compression of the spring.

2. The linear window operator as defined in claim 1, wherein the receiver of the hinge bracket includes two parallel plates that define a gap there-between.

3. The linear window operator as defined in claim 2, wherein the engagement member of the push rod has a thickness substantially equal to the gap between the parallel plates of the hinge bracket.

4. The linear window operator as defined in claim 3, wherein one of the parallel plates has a centrally arranged pivot hole, the first end of the push rod having a pivot pin that is engaged with the pivot hole so as to permit pivoting of the push rod about the pivot pin.

5. The linear window operator as defined in claim 4, wherein the other of the parallel plates has a plurality of detents and the first end of the push rod has a locating bump that is engageable with the detents of the other parallel plate so that the push rod can be located at predetermined angular positions.

6. The linear window operator as defined in claim 1, wherein the flexible member has an engagement detent configured so as to be engageable with the lip of the through opening of the receiver housing.

7. The linear window operator as defined in claim 1, wherein the hinge bracket is a unitary piece of injection-molded plastic.

8. The linear window operator as defined in claim 1, wherein the spring has a free end with a baffle that extends laterally so as to substantially close off a remaining portion of the through-opening when the push rod is in the through opening.

9. The linear window operator as defined in claim 1, wherein the spring member is a cantilever spring having a free end that engages a bottom surface of the push rod.

10. The linear window operator as defined in claim 1, wherein the receiver housing is a unitary plastic injection-molded part.

11. The linear window operator as defined in claim 4, wherein the first end of the push rod has a radiused engagement tongue that engages between the parallel plates of the hinge bracket.

12. The linear window operator as defined in claim 1, wherein the second end of the push rod is provided with a female receiver element having two parallel plates and a pivot hole through one of the plates.

13. The linear window operator as defined in claim 12, wherein the push rod is a unitary part of injection-molded plastic.

14. The linear window operator as defined in claim 12, and further comprising a finger pull member having a first, curved end configured to be engageable by a finger, and a second, male engagement end configured to engage between the parallel plates of the female receiver element of the push rod.

15. The linear window operator as defined in claim 14, wherein the finger pull is a unitary, injection-molded plastic piece.

16. The linear window operator as defined in claim 12, and further comprising an additional push rod of identical construction to the push rod, a first end of the additional push rod having a male engagement member that is engaged in the female receiver element of the second end of the push rod, the second end of the additional push rod having a detent that is engageable with the lip of the through opening in the receiver housing.

17. The linear window operator as defined in claim 16, wherein the second push rod is a unitary, injection-molded plastic part.

18. The linear window operator according to claim 1, wherein the receiver housing has a first plate member with the through-opening and a second plate member attached at an edge thereof to the first plate member so as to project perpendicularly therefrom, the spring member being integral with the second plate member.

19. The linear window operator as defined in claim 1, wherein the hinge bracket includes a base plate, the flexible portion having a curved end opposite the free end, which curved end is connected to the base plate.

20. The linear window operator as defined in claim 16, wherein the other parallel plate of the female receiver element of the push rod has pivot detents and the male engagement member at the first end of the additional push rod has a locating bump that is engageable with the pivot detents.

21. The linear window operator as defined in claim 1, wherein the surface of the receiver housing adjacent the opening has a radiused depression.
